(19) United States
(12) Patent Application Publication
(10) Pub. No.: US 2025/0105317 A1
(43) Pub. Date: Mar. 27, 2025

(54) FUEL CELL SYSTEM AND METHOD OF OPERATING THEREOF USING HUMIDIFIED AMMONIA FUEL

(71) Applicant: BLOOM ENERGY CORPORATION, San Jose, CA (US)

(72) Inventors: Abhishek DUDHMANDE, Mumbai (IN); Amit NAWATHE, Mumbai (IN); Anand SAGAR, Mumbai (IN); Devaraj RAUT, Mumbai (IN); Manikandan CHITHRAVELU, Mumbai (IN); Ian RUSSELL, San Jose, CA (US); David WEINGAERTNER, Sunnyvale, CA (US)

(21) Appl. No.: 18/474,919

(22) Filed: Sep. 26, 2023

(51) Int. Cl. H01M 8/04119; C01B 3/04; H01M 8/0232; H01M 8/04007; H01M 8/04225; H01M 8/04492; H01M 8/04828; H01M 8/0662; H01M 8/12; H01M 8/1246; H01M 8/2425

(52) U.S. Cl. CPC H01M 8/04141; C01B 3/047; H01M 8/0232; H01M 8/04074; H01M 8/04225; H01M 8/045; H01M 8/04835; H01M 8/0662; H01M 8/1246; H01M 8/2425; H01M 2008/1293

(57) ABSTRACT

A fuel cell system includes a stack of fuel cells, a fuel supply line configured to provide an ammonia stream to the stack, and a fuel humidifier configured to humidify the ammonia stream such that a water content of the ammonia stream provided to the stack ranges from about 30% to about 80% by volume.

### FIELD

Aspects of the present invention relate to fuel cell systems and methods, and more particularly, to fuel cell systems configured to operate using humidified ammonia fuel.

### BACKGROUND

Fuel cells, such as solid oxide fuel cells, are electrochemical devices which can convert energy stored in fuels to electrical energy with high efficiency. High temperature fuel cells include solid oxide and molten carbonate fuel cells. These fuel cells may operate using hydrogen and/or hydrogen-containing fuels. There are classes of fuel cells, such as the solid oxide regenerative fuel cells, that also allow reversed operation, such that oxidized fuel can be reduced back to unoxidized fuel using electrical energy as an input.

### SUMMARY

According to various embodiments, a fuel cell system includes a stack of fuel cells, a fuel supply line configured to provide an ammonia stream to the stack, and a fuel humidifier configured to humidify the ammonia stream such that a water content of the ammonia stream provided to the stack ranges from about 30% to about 80% by volume.

According to various embodiments, a method of operating a fuel cell system comprising a stack of fuel cells comprises humidifying anhydrous ammonia to form an ammonia stream, wherein a water content of the ammonia stream ranges from about 30% to about 80% by volume, and providing the ammonia stream to the stack of fuel cells.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIG. 1A is a perspective view of a stack of solid oxide fuel cells, according to various embodiments of the present disclosure. FIG. 1B is a sectional view of a portion of the stack of FIG. 1A.

FIG. 2A is a top view of an air side of an interconnect, according to various embodiments of the present disclosure. FIG. 2B is a top view of a fuel side of the interconnect of FIG. 2A.

FIG. 3 is a schematic view of a fuel cell power module, according to various embodiments of the present disclosure.

FIG. 4 is a top view of an anode-side of a fuel cell shown in FIGS. 1A and 1B that may be included in the stack of FIG. 3.

FIGS. 5A and 5B are schematic views of alternative fuel cell power modules, according to various embodiments of the present disclosure.

FIG. 6 is a schematic view of a power generation system including power modules of FIG. 3, according to an embodiment of the present disclosure.

### DETAILED DESCRIPTION

As set forth herein, various aspects of the disclosure are described with reference to the exemplary embodiments and/or the accompanying drawings in which exemplary embodiments of the invention are illustrated. This invention may, however, be embodied in many different forms and should not be construed as limited to the exemplary embodiments shown in the drawings or described herein. It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

Ranges can be expressed herein as from “about” one particular value, and/or to “about” another particular value. When such a range is expressed, examples include from the one particular value and/or to the other particular value. Similarly, when values are expressed as approximations, by use of the antecedent “about” or “substantially” it will be understood that the particular value forms another aspect. In some embodiments, a value of “about X” may include values of +/−1% X. It will be further understood that the endpoints of each of the ranges are significant both in relation to the other endpoint, and independently of the other endpoint.

In a high temperature fuel cell system, such as a solid oxide fuel cell (SOFC) system, an oxidizing flow is directed to the cathode side of the fuel cell while a fuel flow is directed to the anode side of the fuel cell. The oxidizing flow is typically air, while the fuel flow can be a hydrogen (H₂) or a hydrocarbon fuel, such as methane, natural gas, propane (LPG), ethanol, or methanol. The fuel cell, operating at a typical temperature between 700° C. and 950° C., enables the transport of negatively charged oxygen ions from the cathode flow stream to the anode flow stream, where the oxygen ions combine with either free hydrogen or hydrogen in a hydrocarbon molecule to form water vapor and/or with carbon monoxide to form carbon dioxide. The excess electrons from the negatively charged ions are routed back to the cathode side of the fuel cell through an electrical circuit completed between anode and cathode, resulting in an electrical current flow through the circuit.

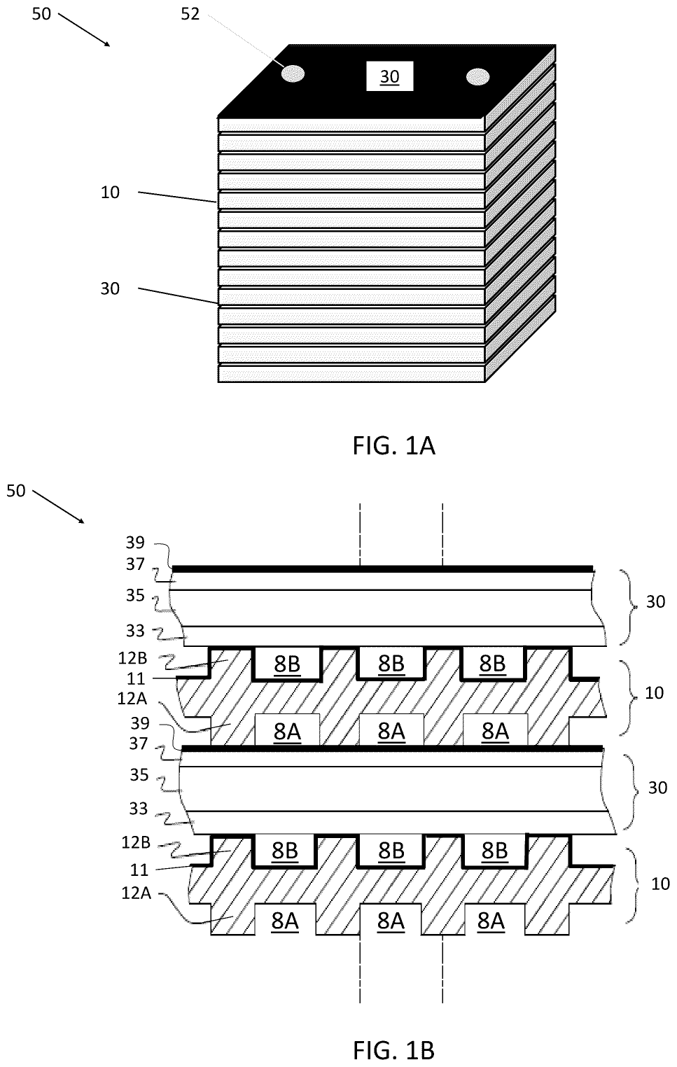

FIG. 1A is a perspective view of a solid oxide fuel cell stack 50, and FIG. 1B is a sectional view of a portion of the stack 50 of FIG. 1A, according to various embodiments of the present disclosure.

In the embodiments below, the stack 50 is described as being operated as a SOFC stack 50 in a power generation mode. However, it should be noted that the stack 50 may also be a reversible fuel cell system which may be operated as an electrolyzer (e.g., a solid oxide electrolyzer cell (SOEC) stack) in electrolysis mode in addition to being operated in the power generation mode.

Referring to FIGS. 1A and 1B, the stack 50 includes fuel cells 30, such as solid oxide fuel cells (e.g., SOFCs) separated by interconnects 10. Referring to FIG. 1B, each fuel cell 30 comprises a cathode electrode 33, a solid oxide electrolyte 35, and an anode electrode 37. In some embodiments, the fuel cells 30 may include a conductive layer, such as a nickel mesh 39, disposed between the anode electrode 37 and an adjacent interconnect 10.

Various materials may be used for the cathode electrode 33, electrolyte 35, and anode electrode 37. For example, the anode electrode 37 may comprise a cermet comprising a nickel containing phase and a ceramic phase. The nickel containing phase may consist entirely of nickel in a reduced state. This phase may form nickel oxide when it is in an oxidized state. Thus, the anode electrode 37 is preferably annealed in a reducing atmosphere prior to operation to reduce the nickel oxide to nickel. The nickel containing phase may include other metals in addition to nickel and/or nickel alloys. The ceramic phase may comprise a stabilized zirconia, such as yttria and/or scandia stabilized zirconia and/or a doped ceria, such as gadolinia, yttria and/or samaria doped ceria.

The electrolyte 35 may comprise a stabilized zirconia, such as scandia stabilized zirconia (SSZ) or yttria stabilized zirconia (YSZ). Alternatively, the electrolyte 35 may comprise another ionically conductive material, such as a doped ceria.

The cathode electrode 33 may comprise an electrically conductive material, such as an electrically conductive perovskite material, such as lanthanum strontium manganite (LSM). Other conductive perovskites, such as LSCo, etc., or metals, such as Pt, may also be used. The cathode electrode 33 may also contain a ceramic phase similar to the anode electrode 37. The electrodes and the electrolyte may each comprise one or more sublayers of one or more of the above described materials. In some embodiments, the fuel cell 30 may include an anode current collector 39, such as a nickel mesh, disposed on the anode electrode 37. The anode current collector 39 may be used to electrically connect the fuel cell 30 to an adjacent interconnect 10.

Cell stacks 50 are frequently built from a multiplicity of SOFC's 30 in the form of planar elements, tubes, or other geometries. Although the stack 50 in FIG. 1A is vertically oriented, fuel cell stacks may be oriented horizontally or in any other direction. Fuel and air may be provided to the electrochemically active surface of the fuel cell, which can be large. For example, fuel may be provided through fuel conduits 52 (FIG. 1) that extend through the stack 50 and that are formed by aligning openings (e.g., holes) formed in the interconnects 10 and fuel cells 30.

Each interconnect 10 electrically connects adjacent fuel cells 30 in the stack 50. In particular, an interconnect 10 may electrically connect the anode electrode 37 of one fuel cell 30 to the cathode electrode 33 of an adjacent fuel cell 30. FIG. 1B shows that the lower fuel cell 30 is located between two interconnects 10. An optional Ni mesh may be used to electrically connect the interconnect 10 to the anode electrode 37 of an adjacent fuel cell 30.

Each interconnect 10 includes fuel ribs 12A that at least partially define fuel channels 8A and air ribs 12B that at least partially define oxidant (e.g., air) channels 8B. The interconnect 10 may operate as a gas-fuel separator that separates a fuel, such as a hydrocarbon fuel, flowing to the fuel electrode (i.e., anode 37) of one cell in the stack from oxidant, such as air, flowing to the air electrode (i.e., cathode 33) of an adjacent cell in the stack. The air and fuel may flow in opposite directions, such that the fuel cell stack 50 has a counter-flow configuration. In alternative embodiments, the air and fuel may flow in opposite directions, such that the fuel cell stack 50 has a co-flow configuration, or the air and fuel may flow in in perpendicular directions, such that the fuel cell stack 50 has a cross-flow configuration.

Each interconnect 10 may be made of or may contain electrically conductive material, such as a metal alloy (e.g., chromium-iron alloy) which has a similar coefficient of thermal expansion to that of the solid oxide electrolyte in the cells (e.g., a difference of 0-10%). For example, the interconnects 10 may each include a metallic substrate comprising a high-temperature stable metal alloy, such as a chromium-iron alloy, such as 4-6 weight percent iron, optionally 1 or less weight percent yttrium and balance chromium alloy and may electrically connect the anode or fuel-side of one fuel cell 30 to the cathode or air side of an adjacent fuel cell 30. An electrically conductive contact layer 39, such as a nickel layer or mesh, may be provided between anode electrodes 37 and a fuel side of each interconnect 10.

An electrically conductive protective layer 11 may be provided on at least an air side of each interconnect 10. The protective layer 11 may be configured to decrease the growth rate of a chromium oxide surface layer on the interconnect 10 and to suppress evaporation of chromium vapor species which can poison fuel cell cathodes 33. The protective layer 11 may be a perovskite layer such as lanthanum strontium manganite (LSM) and may be formed using a spray coating or dip coating process. Alternatively, other metal oxide coatings, such as a spinel, such as an (Mn, Co)₃O₄ spinel (MCO), can be used instead of or in addition to LSM. Any spinel having the composition Mn₂₋ₓCo₁₊ₓO₄ (0≤x≤1) or written as z(Mn₃O₄)+(1-z) (Co₃O₄), where (⅓≤z≤⅔) or written as (Mn, Co)₃O₄ may be used. In other embodiments, a mixed layer of LSM and MCO, or a stack of LSM and MCO layers may be used as the protective layer 11.

Multiple stacks 50 may be arranged on one another to form a column. The column may be internally or externally manifolded for fuel and/or air. Optional anode splitter plates may be disposed between adjacent stacks 50 to provide fuel to the cells of each stack 50 as described in U.S. Pat. No. 10,511,047 B2, which is incorporated herein by reference in its entirety.

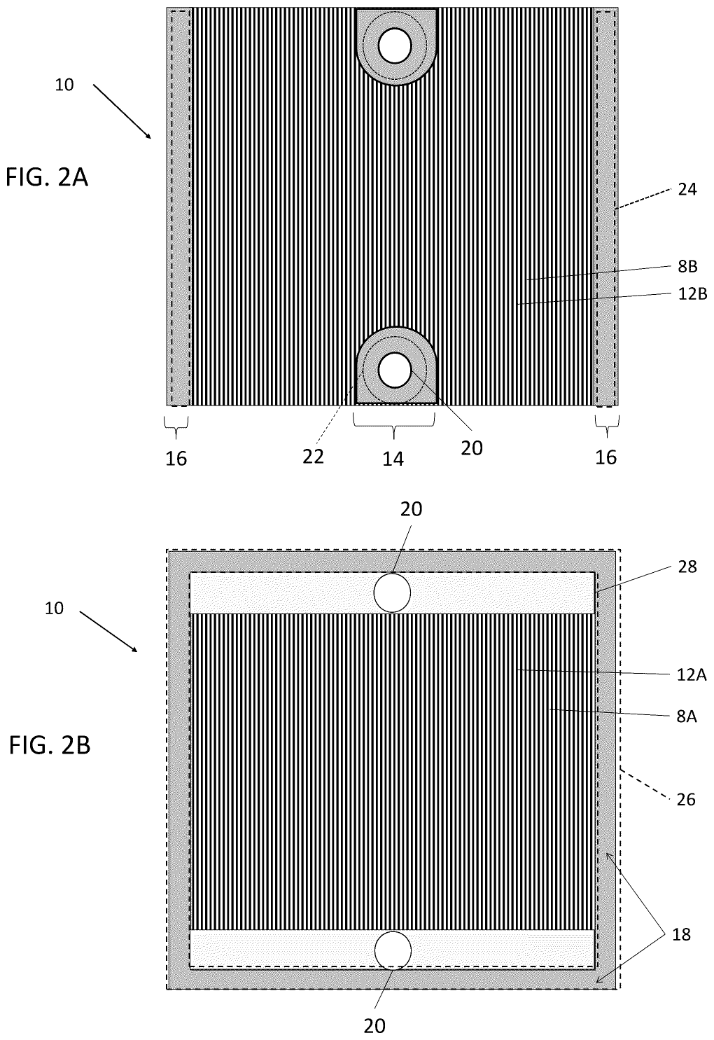

FIG. 2A is a top view of the air side of the interconnect 10, and FIG. 2B is a top view of a fuel side of the interconnect 10, according to various embodiments of the present disclosure. Referring to FIGS. 1B and 2A, the air side includes the air channels 8B. Air flows through the air channels 8B to a cathode electrode 33 of an adjacent fuel cell 30. The interconnect 10 may include ring seal regions 14 and strip seal regions 16. The seal regions 14, 16 may be flat surfaces that are coplanar with the tops of the air ribs 12B. Fuel holes 20 may be formed in the ring seal regions 14 and may extend through the interconnect 10. Ring seals 22 may be disposed on the ring seal regions 14 surrounding the fuel holes 20, to prevent fuel from contacting an adjacent cathode electrode 33. Strip seals 24 may be disposed on the strip seal regions 16. The seals 22, 24 may be formed of a glass or glass-ceramic material. The strip seal regions 16 may be an elevated plateau which does not include ribs or channels.

Referring to FIGS. 1B and 2B, the fuel side of the interconnect 10 may include the fuel channels 8A and optional fuel manifolds 28, which are surrounded by a frame seal region 18. The frame seal region 18 may be a flat region that is coplanar with the tops of the fuel ribs 12A. Fuel flows from one of the fuel holes 20 (e.g., inlet hole that forms part of the fuel inlet riser 52), into the adjacent fuel manifold 28, through the fuel channels 8A, and to an anode 37 of an adjacent fuel cell 30. Excess fuel may flow into the other fuel manifold 28 and then into the other (e.g., outlet) fuel hole 20. A frame seal 26 may be disposed on the frame seal region 18. The frame seal 26 may be formed of a glass or glass-ceramic material.

While a co-flow or counter-flow interconnect 10 is illustrated in FIGS. 2A and 2B, in alternative embodiments, the interconnect 10 may comprise a crossflow interconnect in which the air and fuel channels extend perpendicular to each other, as described in U.S. Pat. No. 11,355,762 B2, which is incorporated herein by reference in its entirety. For example, such interconnects 10 may include two or more fuel holes 20 per side of the interconnect.

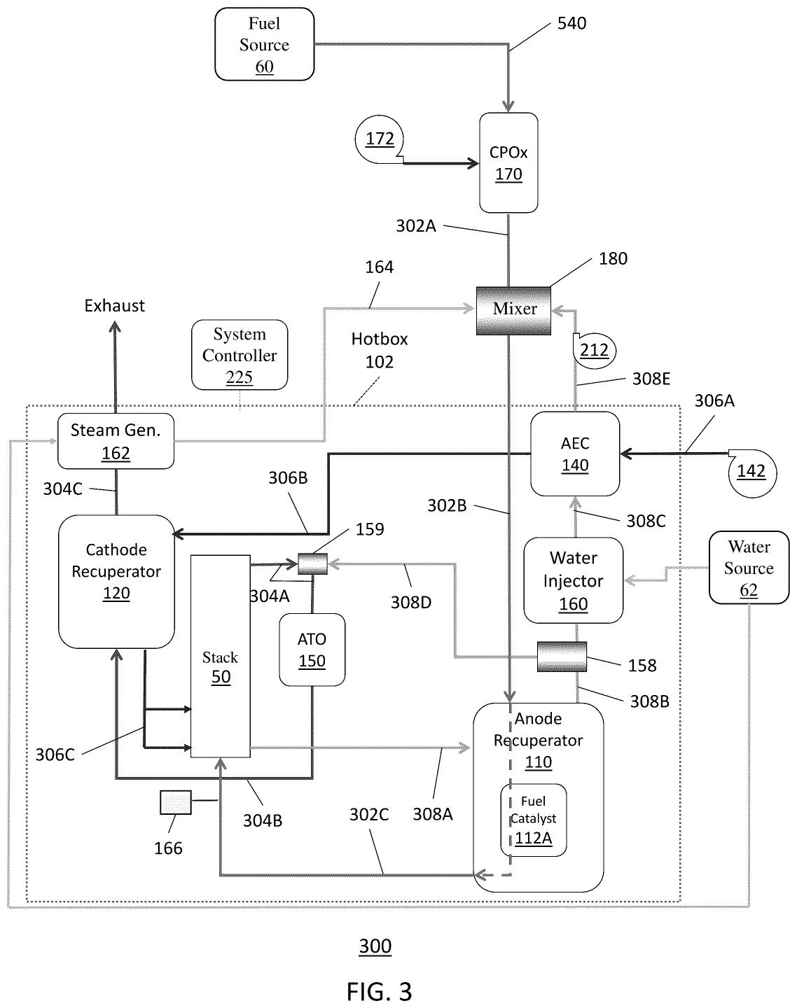

FIG. 3 is a schematic representation of a power module 300, according to various embodiments of the present disclosure. Referring to FIG. 3, the power module 300 includes a hotbox 102 and various components disposed therein or adjacent thereto. The hotbox 102 may contain one or more fuel cell stacks 50, which may be arranged in internally or externally manifolded cell columns as described above.

The hotbox 102 may also contain an anode recuperator heat exchanger heat exchanger 110, a cathode recuperator heat exchanger 120, an anode tail gas oxidizer (ATO) 150, an anode exhaust cooler heat exchanger 140, an optional splitter 158, an optional vortex generator 159, and a water injector 160. Alternatively, the water injector 160 may be replaced with a steam generator 162 that provides steam into the fuel inlet stream. The power module 300 may also include an optional catalytic partial oxidation (CPOx) reactor 170, an optional CPOx blower (e.g., air blower) 172, a mixer 180, a main air blower 142 (e.g., system blower), and an anode recycle blower 212, which may be disposed outside of the hotbox 102. However, the present disclosure is not limited to any particular location for each of the components with respect to the hotbox 102.

Water may be provided to the fuel inlet stream from the fuel source 60 during at least a portion of the start-up operating mode of the power module 300, for example from the time the stack 50 temperature is 200 degrees Celsius until the stack reaches it steady-state operating temperature (e.g., a temperature of at least 700° C., such as 750° C. to 900° C.). During steady-state operating mode, the power module 300 may be operated without a water feed to either the water injector 160 or to the steam generator 162. Thus, during the start-up operating mode of the power module 300, external water is provided from the water source 62 into the power module 300 (e.g., into the water injector 160 or into the steam generator 162) to humidify the anhydrous ammonia. During the steady-state operating mode of the power module 300, provision of external water into the power module 300 may be stopped, and the water containing anode exhaust output from the stack 50 is recycled into the anhydrous ammonia to humidify the anhydrous ammonia.

The power module 300 receives a fuel inlet stream from a fuel source 60 through a fuel supply conduit 540 (e.g., a fuel supply pipe or manifold). The fuel source 60 may be a fuel tank or gas line and may include a valve to control an amount of fuel provided. In particular, the fuel may be provided from the fuel supply conduit 540 to the CPOx reactor 170 (if present). Fuel output from the CPOx reactor 170 may be supplied to the mixer 180, the anode recuperator 110, and the stack 50 by a fuel supply line including fuel conduits 302A, 302B, 302C. In particular, fuel output from the CPOx reactor 170 may be supplied to the mixer by fuel conduit 302A. Fuel (e.g., the fuel inlet stream) flows from the mixer 180 to the anode recuperator 110 through fuel conduit 302B. The fuel is heated in the anode recuperator 110 by anode exhaust (e.g., fuel exhaust) output from the stack 50, and the fuel then flows from the anode recuperator 110 to the stack 50 through fuel conduit 302C.

Air (e.g., air inlet stream) output from the main air blower 142 may be provided to the anode exhaust cooler 140, the cathode recuperator 120, and the stack 50 by an air supply line including air conduits 306A, 306B, 306C. In particular, air may be supplied from the main air blower 142 to the anode exhaust cooler 140 through air conduit 306A. Air flows from the anode exhaust cooler 140 to the cathode recuperator 120 through air conduit 306B. The air is heated by the ATO exhaust in the cathode recuperator 120. The air flows from the cathode recuperator 120 to the stack 50 through air conduit 306C.

An anode exhaust stream (e.g., fuel exhaust stream) output from the stack 50 is provided to the anode recuperator 110, the splitter 158, the vortex generator 159, the water injector 160, the anode exhaust cooler 140, and the mixer 180 by an anode exhaust line including anode exhaust conduits 308A, 308B, 308C, 308D, 308E. In particular, the anode exhaust output from the stack 50 may be provided to the anode recuperator 110 through anode exhaust conduit 308A. The anode exhaust may contain unreacted fuel and may also be referred to herein as fuel exhaust. The anode exhaust may be provided from the anode recuperator 110 to the splitter 158 by anode exhaust conduit 308B. A first portion of the anode exhaust may be provided from the splitter 158 to the anode exhaust cooler 140 through the water injector 160 and the anode exhaust conduit 308C. A second portion of the anode exhaust is provided from the splitter 158 to the ATO 150 through the anode exhaust conduit 308D. The first portion of the anode exhaust heats the air inlet stream in the anode exhaust cooler 140 and may then be provided from the anode exhaust cooler 140 to the mixer 180 through the anode exhaust conduit 308E. The anode recycle blower 212 may be configured to move anode exhaust though anode exhaust conduit 308E.

Cathode exhaust generated in the stack 50 is provided to the ATO 150, the vortex generator 159, the cathode recuperator 120, and exhausted from the hotbox 102 by a cathode exhaust line including cathode exhaust conduits 304A, 304B, 304C. In particular, exhaust flows from the stack 50 to the ATO 150 through cathode exhaust conduit 304A. The vortex generator 159 may be disposed in cathode exhaust conduit 304A and may be configured to swirl the cathode exhaust. The anode exhaust conduit 308D may be fluidly connected to the vortex generator 159 or to the cathode exhaust conduit 304A or the ATO 150 downstream of the vortex generator 159. The swirled cathode exhaust may mix with the second portion of the anode exhaust provided by the splitter 158 before being provided to the ATO 150. The anode exhaust may be oxidized by the cathode exhaust in the ATO 150 to generate an ATO exhaust. The ATO exhaust flows from the ATO 150 to the cathode recuperator 120 through cathode exhaust conduit 304B. The ATO exhaust flows from the cathode recuperator and out of the hotbox 102 through cathode exhaust conduit 304C.

Water is provided from a water source 62, such as a water tank or a water pipe, to the water injector 160. The water injector 160 injects water directly into a first portion of the anode exhaust provided in anode exhaust conduit 308C. Heat from the first portion of the anode exhaust (also referred to as a recycled anode exhaust stream) provided in anode exhaust conduit 308C vaporizes the water to generate steam. The steam mixes with the anode exhaust, and the resultant mixture is provided to the anode exhaust cooler 140. The mixture is then provided from the anode exhaust cooler 140 to the mixer 180 through the anode exhaust conduit 308E. The mixer 180 is configured to mix the steam and first portion of the anode exhaust with fresh fuel (i.e., fuel inlet stream). This humidified fuel mixture may then be heated in the anode recuperator 110 by the anode exhaust, before being provided to the stack 50.

The power module 300 may optionally include a fuel decomposition catalyst 112A located inside and/or downstream of the anode recuperator 110. In some embodiments, the decomposition catalyst 112A may include multiple catalysts, which may be in the form of catalyst “pucks”.

The power module 300 may further a system controller 225 configured to control various elements of the power module 300. The controller 225 may include a central processing unit configured to execute stored instructions. For example, the controller 225 may be configured to control fuel and/or air flow through the power module 300, according to fuel composition data, operating current, and/or operating temperature at any point in the power module 300.

### Ammonia Fuel Operation

Conventional fuel cell systems are designed to operate using hydrogen or a hydrocarbon fuel, such as natural gas, methane, etc. In particular, conventional systems utilize hydrocarbon fuels as a hydrogen source (e.g., hydrogen carrier) for fuel cell reactions.

The power module 300 of FIG. 3 may be operated using hydrocarbon and carbon-free fuels. For carbon-free operations, the power module 300 may be operated using hydrogen (H₂) as a fuel. However, the low volumetric energy density of hydrogen, in both compressed gas and liquid forms, makes the storage of hydrogen a difficult problem for most applications. This limitation is felt most strongly in the area of onboard storage of various vessels, such as ships, etc., but it is also problematic in the delivery and distribution of hydrogen. Hydrogen's low energy density is a challenge to the implementation of hydrogen fueled systems.

In an alternative to hydrogen (H₂) as a fuel, the power module 300 may be operated using a higher energy density, carbon-free hydrogen source, such as ammonia (NH₃). Ammonia fueled solid oxide fuel cell systems offer several advantages. When using ammonia as a fuel source, no carbon oxides (i.e., no CO or CO₂) are present in the anode exhaust or released into the atmosphere, except for the small amount of naturally occurring carbon oxides present in the ambient air that is provided to the power module 300 by the main air blower 142. Ammonia fuel may be easily transported by rail, barge, and trucks as a low pressure liquid. Additionally, solid oxide fuel cell system simplifications and fuel utilization improvements may be realized with ammonia fuel byproduct separation techniques.

Ammonia and air may be provided in the stack 50 to generate electricity. Oxygen ions are transported from the cathode electrode 33 through the electrolyte 35 to the anode electrode 37 of each SOFC 30. The oxygen ions react with the fuel comprising ammonia and/or its decomposed by-product (e.g., hydrogen) to form an anode exhaust stream including nitrogen (N₂) gas, hydrogen (H₂) gas, and water (H₂O) (e.g., water vapor). The anode exhaust stream output from the stack 50 may contain nitrogen, water and optionally other reaction byproducts and impurities, including unreacted hydrogen and/or ammonia depending on whether the fuel and oxygen ion reaction at the anode electrode is complete or not. Thus, no water is required to generate hydrogen from ammonia.

However, the present inventors determined that anhydrous ammonia corrodes the anode current collector (i.e., the nickel mesh 39) of the stack 50. In particular, the current collectors 39 become at least partially detached from some regions of the fuel cells 30, resulting in current collectors 39 sagging into interconnect 10 fuel channels 8A, disrupting fuel flow through the fuel channels 8A. Corrosion and sagging are particularly pronounced adjacent to the fuel inlet holes 20 in the interconnect 10. In response, the present inventors determined that humidifying the ammonia fuel reduces or eliminates the anode current collector 39 corrosion and/or sagging into the fuel channels 8A.

Referring to FIG. 3, according to various embodiments, the fuel source 60 may include a dry (i.e., anhydrous, water free) ammonia fuel source, such as an anhydrous ammonia storage vessel. For example, the fuel source 60 may be configured to provide a gaseous anhydrous ammonia stream to the power module 300, and the power module 300 may be configured to operate using such a fuel. The present inventors discovered that humidifying the anhydrous ammonia stream before it reaches the stack reduces corrosion of the anode current collectors 39 without significantly reducing the power module's power generation efficiency. In one embodiment, the present inventors determined that a humidified ammonia stream including, by volume, from about 30% to about 80%, such as from about 35% to about 75%, including from about 40% to about 60%, such as from about 45% to about 55% water, may significantly reduce anode current collector 39 corrosion and collapse and thus increase the stack 50 operating life.

For example, the power module 300 may include a fuel humidifier configured to increase the water content of the ammonia stream. In some embodiments, the fuel humidifier may comprise the water injector 160. For example, the water injector 160 may be used to inject water into the anode exhaust stream, where the water is vaporized to generate steam that increases the water content of the anode exhaust. The humidified anode exhaust may be mixed with incoming ammonia stream in the mixer 180, such that a humidified ammonia stream is provided to the stack 50 via the anode recuperator 110 and fuel conduits 302B, 302C. The humidified ammonia stream may have a water content as described above, such as a water content of 30 to 80% and an ammonia content of 20 to 70%, by volume.

In an alternative embodiment, the power module 300 may optionally comprise a steam generator 162 that operates as the fuel humidifier, and the water injector 160 may optionally be omitted. In this alternative embodiment, the water source 62 provides water to the steam generator 162 instead of to the water injector 160. The steam generator 162 may be configured to generate steam by extracting heat from the cathode exhaust flowing through the cathode exhaust line (e.g., through conduit 304C). The steam generator 162 may be configured to provide the steam to the mixer 180 via a steam conduit 164, in order to humidify the incoming ammonia stream. In another alternative embodiment, both the water injector 160 and to the steam generator 162 are present in the power module 300 and the same water source or different water sources 62 provide water to both the water injector 160 and to the steam generator 162.

In still other embodiments, water (e.g., water vapor or steam) may be generated by an external water vapor generator or steam generator (not shown) and provided to the power module 300. For example, externally generated water vapor and/or steam may be provided to the mixer 180 or to the fuel supply conduit 540 to humidify the ammonia stream.

The system controller 225 may be configured to control an amount of water (e.g., water vapor and/or steam) that is added to the ammonia stream (e.g., may control the humidity of the fuel stream). For example, during system startup, the controller 225 may be configured such that a relatively large amount of water is provided to the power module 300 and injected into the ammonia stream provided to the stack 50, in order to provide a desired water content in the ammonia stream from the recycled anode exhaust.

Once a desired fuel humidity level is achieved, the controller 225 may be configured to reduce and/or stop the water injection. In particular, substantially all of the water in the ammonia stream provided to the stack 50 may be recycled to the ammonia stream provided to the stack 50 by the recycled anode exhaust. For example, since water is not consumed by the stack 50, the primary source of water loss is due to water contained in the anode exhaust that is provided to the ATO 150. During steady state operation, all of or a substantial fraction of the water output from the power module 300 in the module exhaust may be replaced by water generated in the stack 50. As such, during steady-state operation of the power module 300, the controller 225 may be configured to stop or reduce the amount of water injection into the ammonia stream.

In some embodiments, the power module 300 may include an optional humidity sensor 166 configured to detect an amount of water present in the ammonia stream provided to the stack 50. For example, the humidity sensor 166 may be disposed on fuel conduit 302B and/or 302C. The controller 225 may control the amount of water injected into the ammonia steam based on the amount of humidity detected by the humidity sensor 166. For example, the controller 225 may be configured to maintain the humidity within a desired humidity range, based on the output of the humidity sensor 166, in order to protect the anode current collectors 39 located in the stack 50. In other embodiments, the humidity sensor 166 may be omitted and the controller 225 may be configured to calculate humidity levels based on inputs and outputs of the power module 300. During the steady-state operating mode, the humidity sensor and/or humidity calculation can also be configured to vary the amount of anode recycle provided to the fuel inlet stream, e.g., by varying the speed of anode recycle blower 212.

In various embodiments, the power module 300 may optionally include an ammonia decomposition catalyst 112A in the path of the ammonia stream (i.e., fuel inlet stream) flowing to the stack 50. The decomposition catalyst 112A is configured to decompose (e.g., crack) a portion of the ammonia in the ammonia stream into H₂ and N₂. For example, the decomposition catalyst 112A may include a nickel-based, iron-based, ruthenium-based and/or rhodium-based catalyst configured to thermally crack ammonia. In some embodiments, the decomposition catalyst 112A may include more than one type of catalyst. The decomposition catalyst 112A may be disposed within the anode recuperator 110, such that ammonia provided to the decomposition catalyst 112A is heated by heat extracted from the anode exhaust provided to the anode recuperator 110. As such, the ammonia may pass through the decomposition catalyst 112A at a temperature sufficient to promote a desired ammonia cracking rate. The partial cracking of the ammonia may allow for a reduction in the water content in the ammonia stream provided to the stack 50, since the amount of ammonia provided to the stack 50 is reduced.

In various embodiments, the CPOx reactor 170 may be configured to operate using ammonia. In particular, ammonia oxidation catalysts may be included in the CPOx reactor 170 to generate heat during system startup. In other embodiments, the CPOx reactor 170 may be operated using stored hydrogen, hydrogen generated from ammonia by an external reactor, or using a hydrocarbon fuel (e.g., natural gas, etc.), during system startup. Thus, in start-up mode, hydrogen or hydrocarbon fuel is provided through the CPOx reactor 170 to the stack 50 to heat up the stack 50 to a steady-state operating temperature (e.g., a temperature of at least 700° C., such as 750° C. to 900° C.). After the stack reaches the steady-state operating temperature and enters the steady-state power generation mode, the flow of hydrogen or hydrocarbon fuel into the power module 300 may be stopped and the flow of the ammonia stream fuel into the power module 300 may be initiated, such that the stack 50 operates using ammonia fuel and/or its by-products (e.g., hydrogen from ammonia decomposed by the catalyst 112A) during steady-state power generation mode. In still other embodiments, the CPOx reactor 170 may be omitted and the power module 300 may include a resistive heater designed to heat system components during system startup.

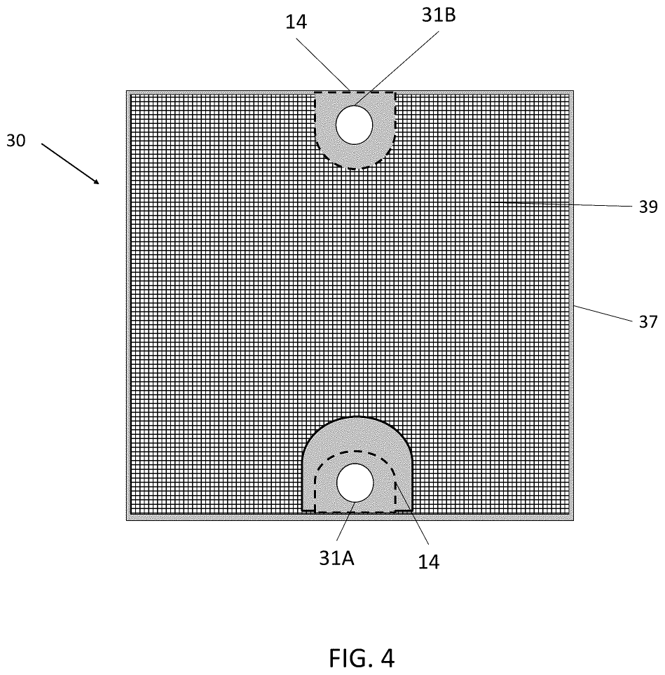

FIG. 4 is a top view of an anode-side of a fuel cell 30 that may be included in the stack 50 of FIG. 3 and as shown in FIGS. 1A and 1B. Referring to FIGS. 1A, 1B, 3, and 4, the current collector 39 is generally not disposed close to fuel inlet and outlet holes 31A, 31B of the cell 30. In other words, the current collector 39 is not disposed on portions of the anode electrode 37 that overlap with the ring seal regions 14 of an adjacent interconnect 10.

The present inventors determined that portions of the current collector (e.g., nickel mesh) 39 that are exposed to the highest concentrations of ammonia suffer from the most corrosion and/or sagging. In particular, current collector sagging and/or corrosion may be concentrated adjacent to the fuel inlet hole 31A and/or between the inlet and outlet holes 31A, 31B. Accordingly, in some embodiments, portions of the current collector 39 located adjacent to the fuel inlet hole 31A may be removed, in order to prevent and/or reduce current collector sagging. For example, a current collector free region around the fuel inlet hole 31A may be larger in area than a current collector free region around the fuel outlet hole 31B, in order to reduce current collector sagging. The current collector free region around the fuel inlet hole 31A may overlap some of the middle fuel channels 8A in the adjacent interconnect 10 in the stack 50.

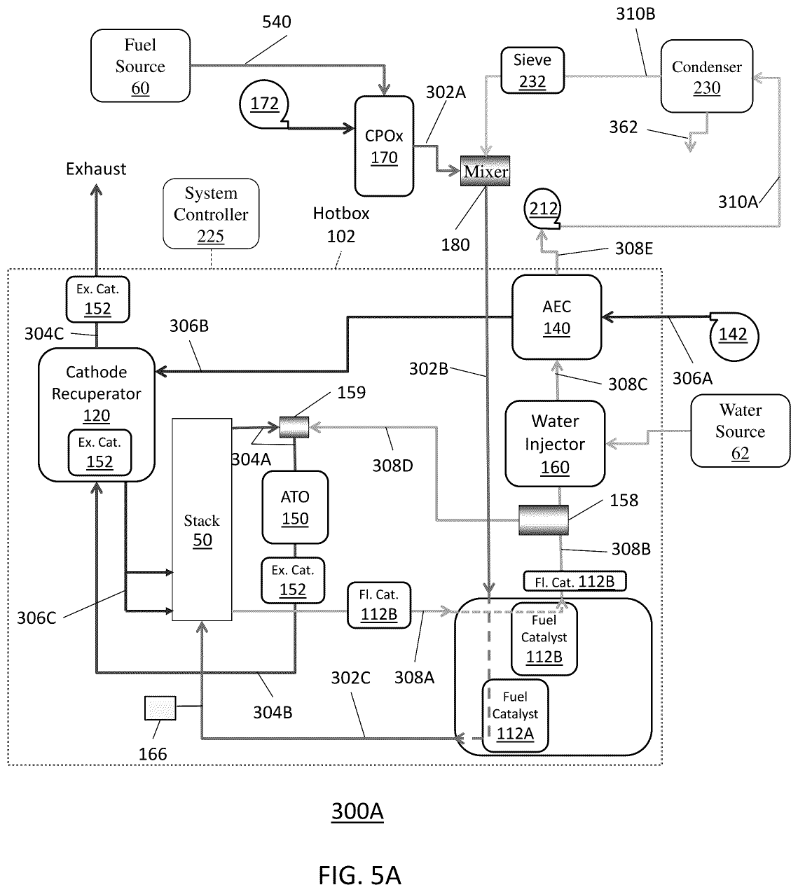

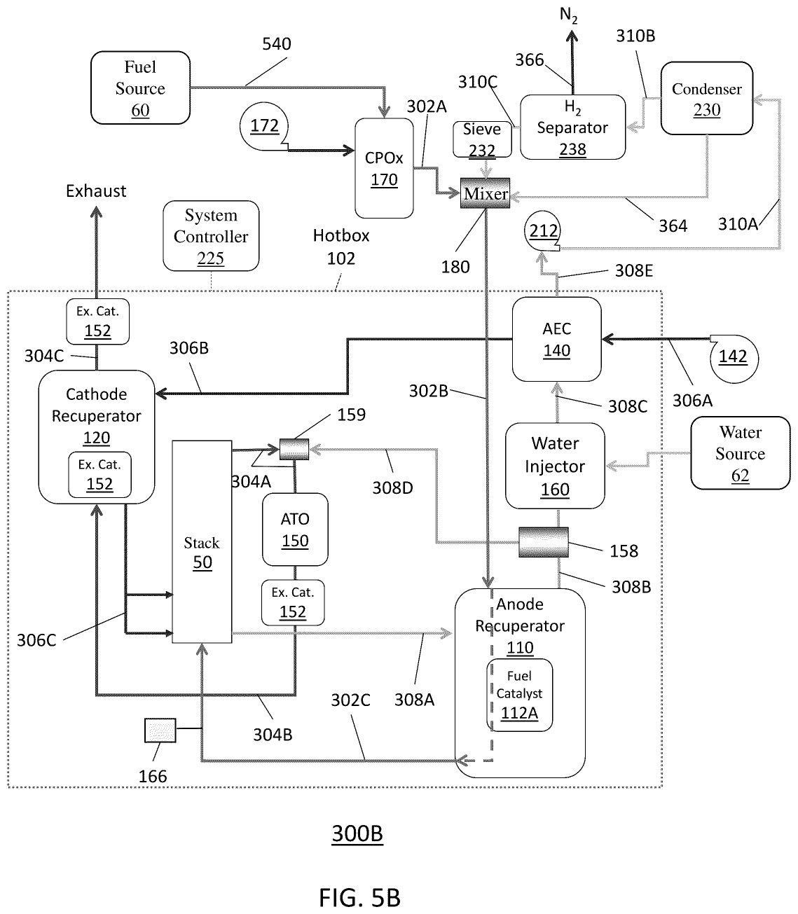

FIGS. 5A and 5B are simplified schematic views of respective alternative power modules 300A and 300B according to various embodiments of the present disclosure. The power modules 300A and 300B may be similar to the power module 300 and may be configured to operate using ammonia as a fuel. As such, only the differences therebetween will be discussed in detail.

Referring to FIG. 5A, the power module 300A may include a condenser 230, a water drain 362, and a recycling line including recycling conduits 310A, 310B. In particular, the condenser 230 may be fluidly connected to the anode recycle blower 212 and the anode exhaust conduit 308E by recycling conduit 310A. The condenser 230 may be configured to condense excess water from the anode exhaust that is in excess of a sufficient amount of water needed to humidify the anhydrous ammonia provided from the fuel source 60. The condensed excess water may be removed from the condenser via the water drain 362 as product water. The remaining anode exhaust containing the sufficient amount of water needed to humidify the anhydrous ammonia is provided to the mixer 180 via the recycling conduit 310B. For example, the sufficient amount of water comprises a volume of water, which when mixed with the anhydrous ammonia provided from the fuel source 60, forms the humidified ammonia stream containing 30 to 80 volume percent water. The amount of excess water removed from the condenser 230 via the water drain 362 may be controlled by controlling an outlet temperature of the anode exhaust exiting from the condenser 230 through the recycling conduit 310B and/or by controlling a temperature and/or flow rate of heat removal media (either air or water) provided to the cold side of the condenser 230, which functions as a heat exchanger to condense the excess water into the water drain 362. Thus, a method of operating the power module 300A includes condensing the excess portion water from an anode exhaust output from the stack 50, and recycling the anode exhaust containing a remaining portion of the water into the anhydrous ammonia to humidify the anhydrous ammonia.

In one embodiment, the power module 300A may optionally include an ammonia decomposition catalyst 112B in the path of the anode exhaust flowing out of the stack 50. During operation of the stack 50, small amounts of ammonia may slip through the anode side of the fuel cells into the anode exhaust. The decomposition catalyst 112B is configured to decompose (e.g., crack) a portion of the ammonia in the anode exhaust into H₂ and N₂. Therefore, if ammonia is present in the anode exhaust, it would not reach the condenser 230 and would not contaminate condensed water product generated in the condenser 230. For example, the decomposition catalyst 112B may include a nickel-based, iron-based, ruthenium-based and/or rhodium-based catalyst configured to thermally crack ammonia. The decomposition catalyst 112B may be disposed within the anode recuperator 110 within the anode exhaust conduit 308A and/or within the anode conduit 308B, because the anode exhaust in these locations is sufficiently hot to promote a desired ammonia cracking rate. In one embodiment, the power module 300A may include both of the above described ammonia decomposition catalysts 112A and 112B on the ammonia stream path and on the anode exhaust path.

In one embodiment, an optional molecular sieve 232 may be added downstream of the condenser 230 to trap unreacted ammonia exiting the condenser 230. For example, the molecular sieve may be located on the recycling conduit 310B. Thus, in various embodiments, the power module may include at least one of the decomposition catalyst 112B disposed upstream of the condenser 230 and configured to decompose at least a portion of the ammonia in the anode exhaust into hydrogen and nitrogen, and/or the molecular sieve 232 disposed downstream of the condenser 230 and configured to trap at least a portion of the ammonia in the anode exhaust. Thus, the ammonia in the anode exhaust may be either decomposed and/or trapped before being recycled into the mixer 180.

Referring to FIG. 5B, the power module 300B may include the condenser 230, a water recycle conduit 364, a hydrogen separator 238, and the recycling line including recycling conduits 310A, 310B, 310C. In particular, the condenser 230 may be fluidly connected to the anode recycle blower 212 and the anode exhaust conduit 308E by recycling conduit 310A. In one embodiment, if the water interferes with the operation of the hydrogen separator 238, the condenser 230 may be operated to condense as much water as possible from the anode exhaust to enhance the operation of the hydrogen separator 238. The amount of water removed from the condenser 230 via the water recycle conduit 364 may be increased by lowering the outlet temperature of the anode exhaust exiting from the condenser 230 through the recycling conduit 310B and/or by decreasing a temperature and/or increasing a flow rate of heat removal media (either air or water) provided to the cold side of the condenser 230. The condensed water may be provided to the mixer 180 via the water recycle conduit 364. In another embodiment, if the water does not interfere with the operation of the hydrogen separator 238, the condenser 230 may be operated as described above with respect to FIG. 5A.

Dried anode exhaust output from the condenser 230 may be provided from the condenser 230 to the hydrogen separator 238 by the recycling conduit 310B. The hydrogen separator 238 may be a hydrogen pump configured to separate hydrogen from nitrogen contained in the anode exhaust. A remainder of the anode exhaust, which may consist primarily of nitrogen gas, may be exhausted from the hydrogen separator 238 via a nitrogen exhaust conduit 366. The separated hydrogen may be provided from the hydrogen separator 238 into the ammonia stream by the recycling conduit 310C. The recycling conduit 310C may be fluidly connected to the mixer 180 or to conduits 302A or 540 to provide the separated hydrogen into the ammonia stream. This increases the fuel utilization of the power module 300B while removing the nitrogen from the recycled anode exhaust stream.

Alternatively, some or all of the hydrogen from the recycling conduit 310C may be provided to a hydrogen storage vessel for additional uses in the power module 300B and/or outside the power module 300B. For example, the stored hydrogen may be provided to the mixer during the start-up mode to heat the power module to the steady-state operating temperature. In another example, the stored hydrogen may be removed and used outside the power module 300B for any other commercial or industrial use.

In one embodiment, an optional molecular sieve 232 may be added downstream of the hydrogen separator 238 to trap unreacted ammonia exiting the hydrogen separator 238. For example, the molecular sieve may be located on the recycling conduit 310C.

In various embodiments, the power module 300A or 300B may include an optional exhaust catalyst 152. The exhaust catalyst 152 may be configured to remove nitrogen containing pollutants, such as unreacted ammonia and/or oxides of nitrogen, as nitric oxide (NO), N₂O, NO₂, and/or NO₃ from the exhaust stream output from the power module 300A or 300B. For example, nitric acid may result from oxidation of the nitrogen containing anode exhaust provided to the ATO 150 via the anode exhaust conduit 308D. In some embodiments, the exhaust catalyst 152 may be disposed on cathode exhaust conduit 304B, in the cathode recuperator 120, and/or on cathode exhaust conduit 304C, depending on a temperature requirement of the exhaust catalyst. For example, the exhaust catalyst 152 may be disposed downstream of the ATO 150 and upstream of the cathode recuperator 120, in the cathode recuperator 120, or downstream of the cathode recuperator 120, with respect to a cathode exhaust flow direction through the cathode exhaust line. In some embodiments, an exhaust temperature in cathode exhaust conduit 304B may be higher than an exhaust temperature in the cathode recuperator 120, which may be higher than an exhaust temperature in cathode exhaust conduit 304C. Optionally, a very small amount of ammonia and/or urea dissolved in water may be provided to the exhaust catalyst 152 if the catalyst comprises a selective catalytic reduction catalyst of the type that is used in diesel engines, etc. The exhaust catalyst 152 may be a nickel-based, iron-based, ruthenium-based and/or rhodium-based catalyst.

In one embodiment, the exhaust catalyst 152 may be omitted if the molecular sieve 232 is present. In another embodiment, the exhaust catalyst 152 may be used in combination with the molecular sieve 232. In this embodiment, the molecular sieve 232 may be located on the recycling conduit 310B or 310C, and/or may be added downstream of the exhaust catalyst 152 (e.g., on the cathode exhaust path) to trap any remaining unreacted ammonia that slips past the exhaust catalyst 152.

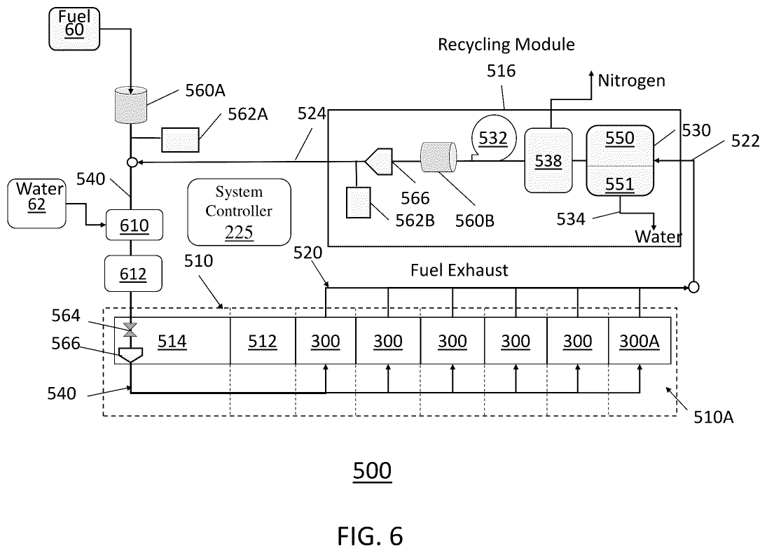

FIG. 6 is a simplified schematic view of a fuel cell power generation system 500 including multiple power modules 300 of FIG. 3, according to various embodiments of the present disclosure. Referring to FIGS. 3 and 6, the power generation system 500 may include one or more cabinets 510 that enclose the multiple power modules 300. For example, each power module 300 may be enclosed in a separate cabinet 510, such as a metal housing containing a door, as shown by the dashed vertical lines in FIG. 6. The cabinets 510 may be arranged on a common base which contains fluid conduits and/or electrical wiring. The cabinets 510 may be arranged in one or more rows and placed adjacent to one another. Alternatively, a single cabinet 510 may enclose plural power modules 300 and the power modules 300 may be arranged in one or more rows in the single cabinet 510. However, the present disclosure is not limited to any particular number of power modules 300 and/or cabinets 510.

The system 500 may also include a power conditioning module 512 and an optional fuel processing module 514 enclosed in the one or more cabinets 510. The power conditioning module 512 may include components for converting the fuel cell generated DC power to AC power (e.g., DC/AC inverters and optionally DC/DC converters described in U.S. Pat. No. 7,705,490, incorporated herein by reference in its entirety), electrical connectors for AC power output to an electrical grid, circuits for managing electrical transients, a system controller (e.g., a computer or dedicated control logic device or circuit). The power conditioning module 512 may be designed to convert DC power from the fuel cell modules to different AC voltages and frequencies. Designs for 200V, 60 Hz; 480V, 60 Hz; 415V, 50 Hz and other common voltages and frequencies may be provided.

The fuel processing module 514 may include fuel processing components, such as a filter and/or fuel flow control and detection elements, such as flow meters, flow control valves 564, fluid flow regulators (e.g., pressure regulators) 566, etc. In the alternative, the fuel processing module 514 may be omitted or utilized for other system components, such as the condenser 530. In various embodiments, the flow control valves 564 may be solenoid valves configured to open or close corresponding conduits.

The power generation system 500 may also include a recycling module 516, a recycling manifold 520 (which may include one or more pipes and/or channels), a first recycling conduit 522, and a fuel supply conduit 540 (e.g., one or more fuel supply pipes). The recycling module 516 may include a second recycling conduit 524, a condenser 530, a recycle blower 532, and an optional hydrogen separator 538.

The recycling manifold 520 may fluidly connect fuel exhaust (i.e., anode exhaust) outlets of each power module 300 to the first recycling conduit 522. The first recycling conduit 522 may fluidly connect the recycling manifold 520 to an inlet of the condenser 530. Thus, the recycling manifold 520 and the first recycling conduit 522 are configured to provide the anode exhaust output from the power modules 300 to the condenser 530.

The condenser 530 may be an air or water-cooled condenser configured to condense water vapor included in the fuel exhaust and output recycled fuel (e.g., mostly dewatered hydrogen and nitrogen). The condenser 530 may also output liquid water condensed from the fuel exhaust via a water drain conduit 534. Specifically, the fuel exhaust may comprise unused hydrogen, nitrogen, and water output from the anode side of the stack 50. Some or all of the water in the fuel exhaust is knocked out (i.e., removed) from the fuel exhaust. The condenser 530 may include a heat exchanger 550 and an optional water collection vessel 551 to collect the condensed water. The heat exchanger 550 and the water collection vessel 551 may be located in the same housing or in separate housings fluidly connected in series. In one embodiment, the heat exchanger may comprise 550 an air-cooled heat exchanger which is configured to cool the fuel exhaust in the first recycling conduit 522 when the fuel exhaust reaches the condenser 530. The heat exchanger 550 may include one or more fans to blow ambient air through the heat exchanger 550 onto the first recycling conduit 522. The water collection vessel 551 is fluidly connected to the water drain conduit 534. The water drain conduit 534 may be fluidly connected to a fuel humidifier 610, which is described below.

The second recycling conduit 524 may fluidly connect an outlet of the condenser 530 to the fuel supply conduit 540. The recycle blower 532 may be a blower or compressor configured to pressurize the recycled fuel (e.g., a dewatered hydrogen and nitrogen mixture) in the second recycling conduit 524. In some embodiments, the recycled fuel may be pressurized to approximately the same pressure as the fresh fuel provided to the fuel supply conduit 540 from the fuel source 60. For example, the recycle blower 532 may output recycled fuel at a pressure ranging from about 0.5 to 5 pounds per square inch gauge (psig), such as from about 1 to about 2 psig.

In some embodiments, the recycling module 516 may optionally include the hydrogen separator 538 configured to increase a hydrogen content of the recycled fuel. In particular, the hydrogen separator 538 may be configured to reduce a nitrogen content of the recycled fuel by separating the nitrogen from hydrogen. The nitrogen may be exhausted from the recycling module 516, while the separated hydrogen is provided to the second recycling conduit 524.

The fuel supply conduit 540 may fluidly connect the ammonia fuel source 60 to each of the power modules 300. The fuel supply conduit 540 may be configured to receive fresh fuel, such as anhydrous ammonia supplied from the fuel source 60. The fuel supply conduit 540 may also receive the recycled fuel (e.g., mostly hydrogen) from the second recycling conduit 524. The fuel supply conduit 540 provides the fresh fuel (e.g., ammonia), the recycled fuel, and water (e.g., water vapor or steam) from the fuel humidifier 610 to the power modules 300.

The system fuel humidifier 610 injects water (e.g., water vapor or steam) into the ammonia stream flowing through fuel supply conduit 540 to the power modules 300. For example, the steam or water vapor may be generated using heat extracted from cathode exhaust output from the power modules 300. Thus, the fuel humidifier 610 may receive water from the water source 62 and/or from the water drain conduit 534 of the condenser 530 and then heat the water using a heat exchanger and/or a heater to generate water vapor or steam. The water vapor and/or steam is then provided into the ammonia stream flowing through the fuel supply conduit 540. The system fuel humidifier 610 may be disposed inside or outside of the cabinets 510. In this embodiment, the water injector 160 and/or the steam generator 162 described above with respect to FIG. 3 may optionally be omitted from the power modules 300.

Thus, in the fuel cell power generation system 500, the stack 50 and the fuel supply line 302A, 302B, 302C of FIG. 3 are located in a first cabinet 510A of first power module 300A, and the fuel humidifier 610 is located outside the first cabinet 510A. The fuel cell power generation system 500 also includes a plurality of additional stacks 50 of fuel cells located in additional cabinets 510 of additional power modules 300. The fuel supply conduit 540 is configured to provide the ammonia stream to the first power module 330A and to the additional power modules 300. The fuel humidifier 610 is located on the fuel supply conduit 540. The condenser 530 is fluidly connected to a fuel exhaust (e.g., portion of the recycling manifold 520) of the first power module 300A and to fuel exhausts (remaining portions of the recycling manifold 520) of the additional power modules 300. The condenser 530 is configured to reduce a water content of the anode exhaust. The hydrogen separator 538 is fluidly connected to an outlet of the condenser 530 and configured to separate hydrogen from nitrogen in the fuel exhaust received from the condenser 530.

The power generation system 500 may also include one or more fluid meters (e.g., flow meters and/or fluid composition sensors) 560, pressure sensors 562, flow control valves 564, fluid flow regulators 566, and/or non-return valves, to control fluid flow to and from the power modules 300. In particular, the power generation system 500 may include a first fluid meter 560A configured to measure fluid flow from the fuel source 60, and a first pressure sensor 562A configured to detect fluid pressure in the fuel supply conduit 540. The power generation system 500 may also include a second fluid meter 560B configured to measure fluid flow in the second recycling conduit 524, and a second pressure sensor 562B configured to detect fluid pressure in the second recycling conduit 524. In one embodiment, the operation of power generation system 500 may be controlled by system controller 225 using pressure control rather than mass flow control. In this embodiment, expensive and complex mass flow control valves, and mass flow controllers (MFCs) that are used in some prior art systems may be omitted to simplify the power generation system 500.

In various embodiments, the power generation system 500 may further comprise the above-described system controller 225 configured to control various elements of the power generation system 500. The controller 225 may include a central processing unit configured to execute stored instructions. For example, the controller 225 may be configured to control the flow control valves 564, fluid flow regulators 566, and/or the recycle blower 532, in order to control the flow of fuel through the power generation system 500.

In some embodiments, the condenser 530, recycle blower 532, and any corresponding fluid meters 560, fluid flow regulators 566, and/or pressure sensors 562 may be arranged in a recycling module 516 and disposed in a separate cabinet, enclosure, room, or structure from the cabinets 510. In other embodiments, the recycling module 516 may be disposed as a separate module in a separate cabinet from the above described cabinets 510, or the recycling module 516 may be included in place of or within the fuel processing module 514. In various embodiments, the multiple cabinets 510 containing the power modules 300 may be fluidly connected to the same recycling module 516.

In various embodiments, anode exhaust coolers 140, mass flow controllers to control fuel flow, and/or fuel exhaust blowers 212 to control fuel exhaust flow, may be omitted from the power modules 300. The fuel processing modules 514 may also be omitted from the power modules, in some embodiments. Accordingly, overall system costs may be reduced by utilizing one condenser 530 and one recycle blower 532 to process the fuel exhaust from the power modules 300.

In some embodiments, the power generation system 500 may include a system ammonia decomposition catalyst 612, as described with respect to FIG. 3, and decomposition catalysts may be omitted from the power modules 300. In particular, the system decomposition catalyst 612 may be configured to decompose a portion of the ammonia stream prior to the ammonia stream being provided to the power modules 300. The system decomposition catalyst 612 may be heated using cathode exhaust output from the power modules 300.

The fuel cell power modules of various embodiments of the present disclosure are designed to reduce greenhouse gas emissions and have a positive impact on the climate.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. A fuel cell system, comprising:
a stack of fuel cells;
a fuel supply line configured to provide an ammonia stream to the stack; and
a fuel humidifier configured to humidify the ammonia stream such that a water content of the ammonia stream provided to the stack ranges from about 30% to about 80% by volume.

2. The fuel cell system of claim 1, wherein the water content of the ammonia stream provided to the stack ranges from about 40% to about 60%, by volume.

3. The fuel cell system of claim 1, wherein the fuel supply line is fluidly connected to an anhydrous ammonia source.

4. The fuel cell system of claim 1, further comprising:
a humidity sensor configured to detect the water content of the ammonia stream; and
a system controller configured to control the water content of the ammonia stream based on the water content detected by the humidity sensor.

5. The fuel cell system of claim 1, further comprising:
a mixer fluidly connected to the fuel supply line; and
an anode exhaust line configured to provide an anode exhaust output from the stack to the mixer, wherein:
the fuel humidifier comprises a water injector fluidly connected to the anode exhaust line and configured to inject water into the anode exhaust flowing through the anode exhaust line, and
the mixer is configured to mix the humidified anode exhaust with the ammonia stream.

6. The fuel cell system of claim 5, further comprising:
an anode recuperator heat exchanger disposed on the anode exhaust line and the fuel supply line; and
an anode exhaust cooler heat exchanger disposed on the anode exhaust line,
wherein the water injector is disposed upstream of the anode exhaust cooler heat exchanger and downstream of the anode recuperator heat exchanger with respect to a flow direction of the anode exhaust through the anode exhaust line.

7. The fuel cell system of claim 6, further comprising a decomposition catalyst disposed in the anode recuperator heat exchanger and configured to decompose at least a portion of the ammonia in the ammonia stream into hydrogen and nitrogen.

8. The fuel cell system of claim 1, further comprising:
an anode exhaust line configured to receive an anode exhaust output from the stack; and
a cathode exhaust line configured to receive a cathode exhaust output from the stack.

9. The fuel cell system of claim 8, wherein:
the fuel humidifier comprises a steam generator configured to generate steam by extracting heat from the cathode exhaust in the cathode exhaust line; and
the steam generator is fluidly connected to the fuel supply line.

10. The fuel cell system of claim 8, further comprising:
an anode tail gas oxidizer (ATO) fluidly connected to the cathode exhaust line and to the anode exhaust line;
a cathode recuperator heat exchanger fluidly connected to the cathode exhaust line; and
an exhaust catalyst configured to reduce at least one oxide of nitrogen content of the cathode exhaust in the cathode exhaust line, wherein the exhaust catalyst is disposed on the cathode exhaust line between the ATO and the cathode recuperator, in the cathode recuperator, or downstream of the cathode recuperator with respect to a cathode exhaust flow direction through the cathode exhaust line.

11. The fuel cell system of claim 8, further comprising:
a condenser fluidly connected to the anode exhaust line and configured to reduce a water content of the anode exhaust; and
at least one of
a decomposition catalyst disposed upstream of the condenser and configured to decompose at least a portion of the ammonia in the anode exhaust into hydrogen and nitrogen; or
a molecular sieve disposed downstream of the condenser and configured to trap at least a portion of the ammonia in the anode exhaust.

12. The fuel cell system of claim 11, further comprising:
a hydrogen separator fluidly connected to an outlet of the condenser and configured to separate hydrogen from nitrogen in the anode exhaust received from the condenser; and
a nitrogen exhaust line fluidly connected to an outlet of the hydrogen separator.

13. The fuel cell system of claim 1, wherein the fuel cells each comprise solid oxide fuel cells comprising:
an anode electrode;
a cathode electrode;
a solid oxide electrolyte disposed between the anode electrode and cathode electrode;
a nickel mesh current collector disposed on the anode electrode; and
fuel inlet and outlet holes,
wherein a nickel mesh current collector free area around the fuel inlet hole is larger than a current collector free area around the fuel outlet hole.

14. The fuel cell system of claim 1, wherein:
the stack and the fuel supply line are located in a first cabinet of first power module; and
the fuel humidifier is located outside the first cabinet.

15. The fuel cell system of claim 14, further comprising:
a plurality of additional stacks of fuel cells located in additional cabinets of additional power modules; and
a fuel supply conduit configured to provide the ammonia stream to the first power module and to the additional power modules, wherein the fuel humidifier is located on the fuel supply conduit.

16. The fuel cell system of claim 15, further comprising a decomposition catalyst fluidly connected to the fuel supply conduit and configured to decompose a portion of the ammonia in the ammonia stream into nitrogen and hydrogen.

17. A method of operating a fuel cell system comprising a stack of fuel cells, the method comprising:
humidifying an anhydrous ammonia to form an ammonia stream, wherein a water content of the ammonia stream ranges from about 30% to about 80% by volume; and
providing the ammonia stream to the stack of fuel cells.

18. The method of claim 17, wherein the humidifying the anhydrous ammonia comprises:
injecting water into an anode exhaust output from the stack to form a humidified anode exhaust stream; and
mixing the humidified anode exhaust stream with the anhydrous ammonia to form the ammonia stream.

19. The method of claim 17, wherein the humidifying the anhydrous ammonia comprises:
converting liquid water into steam in a steam generator using heat from a cathode exhaust output from the stack; and
injecting the steam into the anhydrous ammonia to form the ammonia stream.

20. The method of claim 17, further comprising decomposing at least a portion of the ammonia in the ammonia stream into hydrogen and nitrogen.

21. The method of claim 17, further comprising:
condensing an excess portion water from an anode exhaust output from the stack; and
recycling the anode exhaust containing a remaining portion of the water into the anhydrous ammonia to humidify the anhydrous ammonia.

22. The method of claim 17, further comprising:
condensing water from an anode exhaust output from the stack to form a dewatered anode exhaust;
separating hydrogen from nitrogen in the dewatered anode exhaust; and
recycling the separated hydrogen into the stack.

23. The method of claim 17, wherein:
during a start-up operating mode of the fuel cell system, providing external water into the fuel cell system to humidify the anhydrous ammonia; and
during a steady-state operating mode of the fuel cell system, stopping providing external water into the fuel cell system and recycling a water containing anode exhaust output from the stack into the anhydrous ammonia to humidify the anhydrous ammonia.

24. The method of claim 17, further comprising recycling the anode exhaust containing the water into the anhydrous ammonia to humidify the anhydrous ammonia without condensing the water from the anode exhaust.
